(19) United States
(12) Patent Application Publication
(10) Pub. No.: US 2016/0076898 A1
(43) Pub. Date: Mar. 17, 2016

(54) Itinerary Planner for Selecting Fuel-Efficient Itineraries and for Displaying Offers from Participating Merchants

(71) Applicant: Alex Bitoun, Houston, TX (US)

(72) Inventor: Alex Bitoun, Houston, TX (US)

(21) Appl. No.: 14/484,368

(22) Filed: Sep. 12, 2014

(51) Int. Cl. G01C 21/34

(52) U.S. Cl. CPC G01C 21/3469

(57) ABSTRACT

This business method includes: displaying one or more itineraries (including the shortest route, fastest route and most fuel-efficient route) for travel to both flexible and invariable appointments, updated in real time based on: user's location, destination changes and other factors, and wherein merchants within a defined proximity to the route can display information and offers to the user, and merchants pay the service which makes the itinerary selection services available and collects revenue from merchants for the right to make offers to the users, and determines the order of the merchant in a display to the user.

### FIELD OF THE INVENTION

The invention relates to selecting short, fast and fuel efficient itineraries wherein merchants proximal to the selected itinerary can offer goods, services and specials to the user.

### BACKGROUND

A typical day for a consumer includes travelling to a number of locations for making purchases, viewing entertainment, and keeping fixed appointments. For example, the consumer may need to purchase automobile fuel, buy some groceries, pick up dry cleaning, make a dentist appointment, pick up children after school. The last two scheduled appointments are invariable times and locations, and the first two are flexible. If the consumer wants to add taking in a walk in the park during the day, that activity would usually be flexible—unless meeting someone at a particular time is required.

The questions in selecting an itinerary, after setting the invariable appointments, include, usually, completing the entire schedule of transactions and appointments in the shortest possible time, potentially as also modified by other user priorities, e.g., requiring driving in the most fuel-efficient manner and/or the user's most preferred route, and obtaining the lowest prices on fuel and organic groceries. Considering that completion of the entire schedule depends on all of: traffic flow, lines and waits at merchants and service-providers, prices on fuel, goods and on specials, and the consumer's known habits and preferences—can be updated in real time through GPS identification of the user's location and electronic transmission of updated information based on user's location, the selection of an itinerary that best fit the consumer's desires involves a huge number of variables, that change constantly. The complex itinerary selection with real time updates and modifications provides the ability to increase fuel savings through also selecting the shortest or most fuel-efficient route on a continuously updated basis.

Such a selection system can be part of a business where merchants proximal to the route can advertise, for a fee, by displaying goods, services, prices and specials to the user both before the itinerary is selected, and also while the consumer is en route. The system should also account for known preferences of the user (based on prior selections) and those of other consumers (including as available on the internet) all in real time.

### SUMMARY

This business method includes: displaying one or more itineraries (including the shortest route, fastest route and most fuel-efficient route) for travel to both flexible and invariable appointments, updated in real time based on: user's location, destination changes and other factors, and wherein merchants within a defined proximity to the route can display information and offers to the user, and merchants pay a service which makes the itinerary selection services available and collects revenue from merchants for the right to make offers to the users. The itinerary selection can include information gained in an internet-linked or other wireless-linked interaction with another microprocessor (e.g., a central server), or a wireless-linked interaction with the internet only.

The itinerary displayed further allows selection of: desired arrival times at destinations (as needed for invariable appointments), reaching a certain number of destinations within a certain amount of time, or reaching certain destinations in a particular order. The itinerary displayed is affected by a number of factors, which can be determined in the itinerary planning and changed thereafter and displayed, including:
traffic flow along routes (as updated);
estimated time spent at destinations after arrival at destinations;
business hours of destinations;
changes in routing or destinations en route;
third-party feedback or information relating to rating desirability of particular routes, destinations or establishments;
user's past preferences for certain routes, products, services, prices, quality, specials, discounts, routes or establishments;
user's demographics, income, age, and interests; and
merchant's offers of particular products, services, prices, quality, specials and discounts.

The order of display of merchant's offers on the user's device can be a strong influence on the user's purchasing propensity. The merchants or goods displayed first on a list are more likely to be selected than those listed lower, especially considering the list will be displayed and changed as the driver is moving. The order of display can be one which best fits the user's known habits, propensities, or pre-programmed desires, or one which merchants can influence, to raise their chances of user patronage. The order of display can be controlled or affected by any factor affecting the itinerary displayed (above list), as well as others.

### DETAILED DESCRIPTION

A user is provided with a micro-processor device (a static or a mobile device, including a mobile phone, a smart phone, a personal digital assistant [PDA], a PDA phone, a notebook or tablet computer, a game device, a multimedia player or a PC) which can access the internet, and which runs a routing and itinerary-selection program which can be provided as an App, an upload, or by other means typically used to enable the micro-processor to run the program.

The program is capable of planning and displaying an itinerary for the user which involves multiple variables at the outset, most of which can also be changed en route. The user is also provided with a GPS which interacts with the device. See e.g. US Publn No. 20050096840 (incorporated by reference). Through the internet-based interaction with the GPS and the device, the program constantly updates the itinerary and information, as well as advertising and offers from merchants and other third parties, based on their proximity to the route, and on other factors.

The program allows accomplishing the goals of the system described in U.S. Pat. No. 7,729,708 (incorporated by reference), allowing goal-oriented setting of a route, where the goal can be arrival times at destinations, reaching a certain number of locations within a certain amount of time, or reaching certain destinations in a particular order. The goals of the system described herein includes the foregoing goals, as well as others, including selecting the shortest route to destinations, fastest route, or the most fuel-efficient route. The route selection of the present system includes real-time interaction with the internet and/or a server, and real-time itinerary changes and updating based on information from the internet or the server, including from routing APIs (like Google's mapping/routing API).

In one embodiment, new proposed itineraries can be continuously displayed on the user device, or proposed itineraries can be filtered or ranked based on any of number of criteria. For example, the user may only want to see information (or may want to see it first on a list) that allows maintaining the fastest, shortest or most fuel-efficient route, if selected. Preferably, any display reflecting any consideration used in routing, or reflecting other considerations relating to shopping, activities, appointments, services, fuel or others discussed herein, can be listed lower than others, or filtered out and not displayed at the user's option.

Based on the location of the user, he is sent offers, including discounts from merchants and service providers, as discussed in US Publ′n No. 20130268353 and 20140058841 (both incorporated by reference). The purchasing attributes of the user or the user's intention to purchase can be taken into account as well in selecting offers or discounts displayed, as described in US Publ′n No. 20130268353 or 20140058841.

In a preferred embodiment, the user's or other user's preferences based on experience with particular routes, or the user's or other users' experience with locations within the required proximity the user (e.g., merchants, service and lodging providers, entertainment facilities, parks and recreation locations and other places of public accommodation), and such experience with particular goods, services, entertainment fare, or activities available at a location, is also considered in selecting or ordering the offers to display. The preferences of others can be determined from internet sources while en route, including on line rating services, e.g. Yelp, Angie's List, or other on line reviews or ratings services. User preferences can be determined by user input, or by determining and storing the user's past similar itineraries, and then analysing that information, along with the related GPS data and information, to determine which locations the user actually went to or patronized (automatic preference determination).

The preferred routes along the itinerary could also be automatically selected, based on user preference. For example, where the user was shown to be selecting a route which required driving further and/or taking longer (as determined from the user's stored information based on GPS tracking), that route would receive a higher ranking weight than others. The display could be based on ranking weight, showing, for example most to least preferred in order. If the user selected the same route on multiple occasions, the ranking weight could be further increased. The ranking weight of the other non-selected routes could be reduced, and preferably would be further reduced if they were faster or shorter than the selected routes.

When using automatic preference determination, there are a number of ways of selecting the most preferred and least preferred locations (and merchants, goods, services, entertainment) for display. In one method, if the user previously had a location displayed on an itinerary as suitable, but ignored it and drove a longer distance to another location offering the same goods, services or activities, the non-selected location could be given a lower weight. Similarly, in such case, the location selected could be given a higher weight than others because it was selected, and then a further increase in weight because it required additional travel to reach it. If the user selected this location multiple times, that could be a further added weight; and the non-selected location could be given a further reduced weight, having not been selected multiple times.

Most preferred and least preferred locations for display could also be weighted based on the fact that the user selected certain offers, as shown by the user travelling to the location of their origin. If the offers accepted for certain merchants were for goods at higher prices than those from another merchant in a similar itinerary, that merchant for those goods could be given a yet higher weight, and the other merchants' ranking weights would be reduced. And again, multiple instances of selecting a particular merchant on an itinerary multiple times, would also entitle it to a higher weight, while other merchants offering similar goods would have their ranking weight reduced.

Other factors affecting the ordering of the displayed goods, services and activities are the similarity or difference of displayed goods, services and activities to those associated with the user's intended activities, purchases and appointments. Generally more similar goods, services and activities would be weight ranked higher than less similar ones. For example, the user may show a preference for organic food, based on prior travel to organic food merchants and/or restaurants. The system would preferably weight rank and display organic grocery stores and restaurants higher than others.

The itinerary planning and interaction with the user, and identification of the user's location in real-time through a GPS, can be used to refine the user's preferences. Travel to a location alone, without the user remaining there for a length of time to indicate a transaction or activity (like seeing a movie or walking in a park) actually took place, can be used in determining the weight ranking of the location for subsequent displays. In such case, the likely explanation is that the user did not, upon arrival, like the goods or services or activities available at the location. The displays can be set so that in such case, the location's weight ranking is reduced, or is neutral.

The same weighting and ranking system could be applied to selection of non-merchant locations, such as service and lodging providers, entertainment facilities, parks and recreation locations and other places of public accommodation. The desirability of the location could be assumed and given increased weight based on number of user visits, where it was a similar distance or drive time from the user as other locations, and further increase-weighted if it was a longer distance or drive time, or further reduce-weighted if it was shorter drive time than the location selected.

Merchants and other active members of the system would have the opportunity to influence their ranking weight, for display to at least those users who agreed to such influence as part of the system. This allows funding of the system and service. The system can also be designed so that a server controls the microprocessors of the users, and the server only allows users to access information only about those merchants who paid their fees, and the server is involved in providing the ranking weight, as influenced by merchants or and other active members of the system.

Where a server is controlling displays, it also allows charging merchants for displays based on: the number of users their business or products were displayed to; the number of times in a specified period their business or products were displayed; the number of times users who received the display of their business or products travelled to their location; or the number of times users who received the display of their business or products travelled to their location and remained there for a period indicating a transaction took place.

An exemplary pseudocode for carrying out some steps in the method described herein is set forth below.

Example: Pseudocode for Itinerary Selection

// prompt the user for his destination
LocationDestination = PromptUserForDestination( )
// get the user current location or start of the route - use GPS but allow to override
OriginDestination = GetUserLocation( )
// what is the user looking for - that could be directly entered or from a list of to do items
OnTheWayStopSearch = GetUserSearchItem( )
// process the search results and store them in a WayPointRoutes array
For ( int i = 0; i < OnTheWayStopSearch results; i++)
{

// get the search result item details
WayPointSearchLocation = OnTheWayStopSearch[i];
// do a way point search via google or other engine to see time/distances
// capture info in WayPointRoute about specifics time/distance/energy efficiency
WayPointRoute = DoWayPointGoogleAPISearch( Origin, Destination,

WayPointSearch)

WayPointRoutes[i].Add( WayPointRoute);

}
// now that we have all routes compare them and get best alternatives
// by time - add the time of all entries based on traffic conditions etc... for the route - sort lowest
first
BestRoutesByTimeList = GetOrderedRoutesBasedOnShortestDirectionTimes( )
// by distance - add the driving distances of all way points - sort shortest first
BestRoutesByDistanceList = GetOrderedRoutesBasedOnShortestDirectionDistances( )
// by settings - order based on items such as organic food only, avoid certain business entities
etc... get routes - remove all routes including “not desired” locations - give preference to
“liked/selected” locations
BestRoutesByProfileSettingsList = GetOrderedRoutesBasedOnProfileSettings( )
// by energy - distance/time/traffic - type of car used in profile to determine most efficient path
BestRoutesbyEnergySavingsList = GetOrderedRoutesBasedOnEnergySavingCriterias( )
/***** NOW THAT WE HAVE PATHS - DISPLAY TO USER FOR SELECTION ****/
DisplaySuggestedRoutes( ) // offer ability to look by various sorting
MapOutSelectedRouteForUser( ) // pass through Google Map / Map Service to allow user to go
through actual route selected
// every time a user goes through a route, get rating information to gather additional data to
improve personalized experience for this user and others as well
CollectAndStoreRouteStopsRatings( )
***************************************************************************

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing, by Applicants. The invention has been described broadly and generically herein. Each of the narrower species and subgeneric groupings falling within the generic, disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method of generating revenue and promoting energy conservation by determining and displaying the shortest and most fuel efficient routes for an itinerary of intended appointments and activities of a user, wherein merchants are charged for being displayed to users of the service, comprising:
programming a microprocessor to record the user's intended activities and their locations, the goods or services or the type of goods and services the user intends to purchase, and the times and locations of the user's appointments;
programming the microprocessor to access the internet in order for the microprocessor to determine all of the following and to display one or more of the following:
(i) the most fuel efficient route between said intended activities, purchases and appointments;
(ii) the shortest route between said intended activities, purchases and appointments;
(iii) fastest route for completing said intended activities, purchases and appointments based on transit time to and anticipated time to complete each of the intended activities, purchases and appointments;
programming the microprocessor to access a server or website through the internet whereby the microprocessor displays goods, services and activities which are the same as or are related to those associated with the intended activities, purchases and appointments, and locations offering said displayed goods, services and activities which are within a specified proximity to a location on at least one of the determined routes or the user's actual location at a particular time, and which are listed in a particular order based on one or more of the following factors:
(i) the proximity to the determined route or the user's actual location;
(ii) the similarity or difference of displayed goods, services and activities to those associated with the intended activities, purchases and appointments;
(iii) the user's and/or other user's experience with and preferences for the route, or the goods, services and activities displayed; and
(iv) payment by merchants.

2. The method of claim 1 further including the steps of receiving the user's location along the route as determined by a GPS carried by the user which is linked wirelessly to the internet.

3. The method of claim 2 wherein the GPS or the microprocessor is wirelessly linked to a server which stores information from the microprocessor and/or the internet.

4. The method of claim 1 further including assigning a weighting rank to determine the order of display of displayed goods, services and activities, wherein the weighting rank is based on the number of times the user previously visited a particular location on a displayed itinerary, and the distance the user travelled to a particular location on a displayed itinerary as compared with locations offering similar goods, services or activities.

5. The method of claim 4 wherein the weighting rank is also determined by whether the user remained at the location long enough to indicate a transaction took place.

6. The method of claim 1 wherein the preferences of others can be determined from on line rating services.

7. The method of claim 1 wherein the user preferences are directly input by the user.

8. The method of claim 1, wherein the microprocessor displays coupons and specials of the merchants within particular proximity to the user's route.

9. A method of generating revenue by determining and displaying an itinerary of intended appointments and activities of a user which changes as the user's location changes, wherein merchants are charged for being displayed to users of the service, comprising:
programming a microprocessor to record the user's intended activities and their locations, the goods or services or the type of goods and services the user intends to purchase, and the times and locations of the user's appointments;
programming the microprocessor to access the internet in order for the microprocessor to display one or more of the following:
(i) the most fuel efficient route between said intended activities, purchases and appointments;
(ii) the shortest route between said intended activities, purchases and appointments;
(iii) fastest route for completing said intended activities, purchases and appointments based on transit time to and anticipated time to complete each of the intended activities, purchases and appointments;
programming the microprocessor to access a server or website through the internet whereby the microprocessor displays goods, services and activities which are the same as or are related to those associated with the intended activities, purchases and appointments, and locations offering said displayed goods, services and activities which are within a specified proximity to the user's actual location at a particular time, and which are listed in a particular order based on one or more of the following factors:
(iv) the proximity to the determined route or the user's actual location;
(v) the similarity or difference of displayed goods, services and activities to those associated with the intended activities, purchases and appointments;
(vi) the user's and/or other user's experience with and preferences for the route, or the goods, services and activities displayed; and
(vii) payment by merchants who are part of the system.

10. The method of claim 9 further including the steps of receiving the user's location along the route as determined by a GPS with the user which is linked wirelessly to the internet.

11. The method of claim 10 wherein the GPS or the microprocessor is wirelessly linked to a server which stores information from the microprocessor and/or the internet.

12. The method of claim 9 further including assigning a weighting rank to determine the order of display of displayed goods, services and activities, wherein the weighting rank is based on the number of times the user previously visited a particular location on a displayed itinerary, and the distance the user travelled to a particular location on a displayed itinerary as compared with locations offering similar goods, services or activities.

13. The method of claim 12 wherein the weighting rank is also determined by whether the user remained at the location long enough to indicate a transaction took place.

14. The method of claim 9 wherein the preferences of others can be determined from on line rating services.

15. The method of claim 9 wherein the user preferences are directly input by the user.

16. The method of claim 9, wherein the microprocessor displays coupons and specials of the merchants within particular proximity to the user's route.

17. A method of generating revenue by determining and displaying an itinerary of intended appointments and activities of a user which changes as the user's location changes, wherein merchants are charged for being displayed to users of the service, comprising:
programming a microprocessor to record the user's intended activities and their locations, the goods or services or the type of goods and services the user intends to purchase, and the times and locations of the user's fixed and invariable appointments;
programming the microprocessor to access the internet in order for the microprocessor to display the fastest and most fuel efficient routes for completing said intended activities, purchases and appointments based on transit time to and anticipated time to complete each of the intended activities, purchases and appointments;
programming the microprocessor to access a server or website through the internet whereby the microprocessor displays goods, services and activities which are the same as or are related to those associated with the intended activities, purchases and appointments, and locations offering said displayed goods, services and activities which are within a specified proximity to the user's actual location at a particular time, and which are listed in a particular order based on one or more of the following factors:
(i) the proximity to the determined route or the user's actual location;
(ii) the similarity or difference of displayed goods, services and activities to those associated with the intended activities, purchases and appointments;
(iii) the user's and/or other user's experience with and preferences for the route, or the goods, services and activities displayed; and
(iv) payment by merchants who are part of the system.

18. The method of claim 17 further including the steps of receiving the user's location along the route as determined by a GPS with the user which is linked wirelessly to the internet.

19. The method of claim 17 wherein the fastest route allows the user to arrive at invariable appointments at a designated time.

20. The method of claim 19 wherein the estimated time after arrival at invariable appointments is used in determining the fastest route.
